(19) United States
(12) Patent Application Publication
(10) Pub. No.: US 2015/0209960 A1
(43) Pub. Date: Jul. 30, 2015

(54) SYSTEM AND METHOD FOR DETERMINING AN OPTIMAL TRAJECTORY FOR MATERIAL DISPENSING ROBOTS

(71) Applicant: ABB TECHNOLOGY AG, Zurich (CH)

(72) Inventors: Xiongzi Li, West Hartford, CT (US); Oyvind A. Landsnes, Mandal (NO); Thomas A. Fuhlbrigge, Ellington, CT (US); Steinar Riveland, Klepp stasjon (NO); Carlos Martinez, New Britain, CT (US); Christoffer Apneseth, Stavanger (NO)

(21) Appl. No.: 14/420,100

(22) PCT Filed: Jul. 23, 2013
(86) PCT No.: PCT/US2013/051552

§ 371 Date: Feb. 6, 2015

Related U.S. Application Data
(60) Provisional application No. 61/680,787, filed on Aug. 8, 2012.

(51) Int. Cl. B25J 9/16; G06F 17/50

(52) U.S. Cl. CPC B25J 9/1671; G06F 17/5009; G05B 2219/35343; G05B 2219/45065; Y10S 901/43

(57) ABSTRACT

A system for tuning robot trajectory to obtain optimal material thickness on an object includes at least one robot adapted to dispense material, a controller connected to the robot to control movement of the robot and to dispense material in relation to the object. A tuner is connected to the controller to iteratively simulate dispensing of the material on the object based on movement of the robot, and to adjust dispensing of the material and movement of the robot to obtain a desired material thickness on the object based on the iterative simulations. A related method to optimize dispensing material on an object includes simulating a path trajectory of a material dispensing robot in relation to an object is also disclosed.

### TECHNICAL FIELD

The present invention is generally related to robot simulations. Specifically, the present invention is related to material dispensing robot simulations and adapting those simulations for actual use by a robot or robots.

### BACKGROUND ART

It is well known in various industries to use robots in the assembly of large quantities of manufactured goods. Robots are used in automated assembly of automobiles, circuit boards, computers, the manufacture of food, and many other items. Robotics provide advantages over manual labor in cost savings in view of their ability to perform boring and repetitive tasks very well with minimal error.

One such task is the painting of automobile exterior body parts. Similar material dispensing robots are also used in general industries for the manufacture of airplane components, windmills, busses, trains and the like. Although robots provide a clear time savings advantage in operation, setting up a robot to perform a specific task is a cumbersome process. In paint application processes, care must be taken so that desired paint coverage is obtained with minimal waste.

The programming of a painting robot by a paint application specialist is an expensive, wasteful and time-consuming process. First, the specialist programs the robot by teaching surface positions of an object point-by-point, or by using an off-line programming software system. The robot then applies the paint and then the specialist measures the paint thickness over the surface of the actual object. In order to obtain uniform paint coverage over the entire object, the specialist may have to modify the robot's trajectory program and repeat the process a number of times until a satisfactory result is received.

Known attempts at simulating the paint process and estimating the paint thickness have been unsuccessful.

There are two known methods to simulate the painting process and calculate the thickness of paint deposited on the surface of an object. The first is to model the static profile of the paint thickness using Gaussian Functions and then to project the model along the path of the robot dispensing the paint. The problem with this approach is that it does not model any of the physical properties of the paint dispensing operation. For example, the model does not provide for consideration of the gravity, viscosity or electro-static effects of the paint particles near a curved surface, and so on. Although the Gaussian Function appears to work with flat surfaces it does not work well with curved or doubly curved surfaces. The other approach to calculating the thickness of paint deposited on a surface is to utilize computations fluid dynamics models. Unfortunately, this approach requires massive computing power to calculate the iterative model using numerical methods. It is believed that such an approach would require days to calculate a small amount of paint dispensed from a robot-controlled nozzle. Accordingly, such methods are not realistic for implementation in a simulation that needs to be run relatively quickly.

Based on the foregoing it is clear that there is a need for an integrated iterative tuning software for robot path trajectory based on paint thickness simulation data. And there is a need for simulation software able to predict the paint thickness deposition on the surface of the object and provide the user guidance as to how to adjust the robot program in order to achieve uniform paint coverage on the object and also on a group of adjacent objects. Moreover, there is a need for tuning software that can be taken from the simulated virtual environment and implemented into a real-time painting operation.

### SUMMARY OF THE INVENTION

In light of the foregoing, it is a first aspect of the present invention to provide a system and method for determining an optimal trajectory for material dispensing robots.

It is another aspect of the present invention to provide a system for tuning robot trajectory to obtain optimal material thickness on an object, comprising at least one robot adapted to dispense material, a controller connected to the robot so as to control movement of the robot and dispensing of the material in relation to the object, and a tuner connected to the controller to iteratively simulate dispensing of the material on the object based on movement of the robot, and to adjust dispensing of the material and movement of the robot to obtain a desired material thickness on the object based on the iterative simulations.

Yet another aspect of the present invention is a method to optimize dispensing material on an object, comprising simulating a path trajectory of a material dispensing robot in relation to an object, simulating dispensing of material along the path trajectory, determining a relative thickness of material on the object, and tuning the simulating steps to adjust and obtain a desired relative thickness of the material on the object.

Still another aspect of the present invention is to provide a method of predicting coverage and relative thickness of material dispensed by at least one robot on at least one object, comprising displaying a multi-dimensional view of the at least one object, the at least one robot, and a trajectory of the at least one robot in relation to the at least one object, simulating the trajectory along with inputs and outputs that control the material dispensed, recording the output of the simulation, simulating the material flow from said at least one robot on to the at least one object, and generating and displaying a material thickness representation on the object.

Yet another aspect of the present invention is a method for simulating material flow on to an object comprising representing a multi-dimensional object on a display, simulating motion of a movable material dispensing device in relation to the multi-dimensional object on the display, simulating on the display a flow of material from the movable material dispensing device onto the multi-dimensional object and representing accumulation of material on the multi-dimensional object for viewing on the display.

### BRIEF DESCRIPTION OF THE DRAWINGS

These and other features and advantages of the present invention will become better understood with regard to the following description, appended claims, and accompanying drawings wherein:

FIG. 1 is a schematic diagram of a material application system according to the concepts of the present invention;

FIG. 2 is a perspective view of an object to be painted with markers positioned for use in determining a simulated path trajectory;

FIG. 3 is a perspective view of the object with markers and a robot utilized to identify positioning of the markers in establishment of the simulated path trajectory;

FIG. 4 is a schematic representation of an initial path trajectory in relation to the object according to the concepts of the present invention;

FIG. 5 is a representation of material being dispensed during a simulation according to the concepts of the present invention;

FIG. 6 is a schematic two-dimensional representation of material thickness on an object after a simulation according to the concepts of the present invention; and

FIG. 7 is a schematic three-dimensional representation of material thickness on an object after a simulation according to the concepts of the present invention.

### BEST MODE FOR CARRYING OUT THE INVENTION

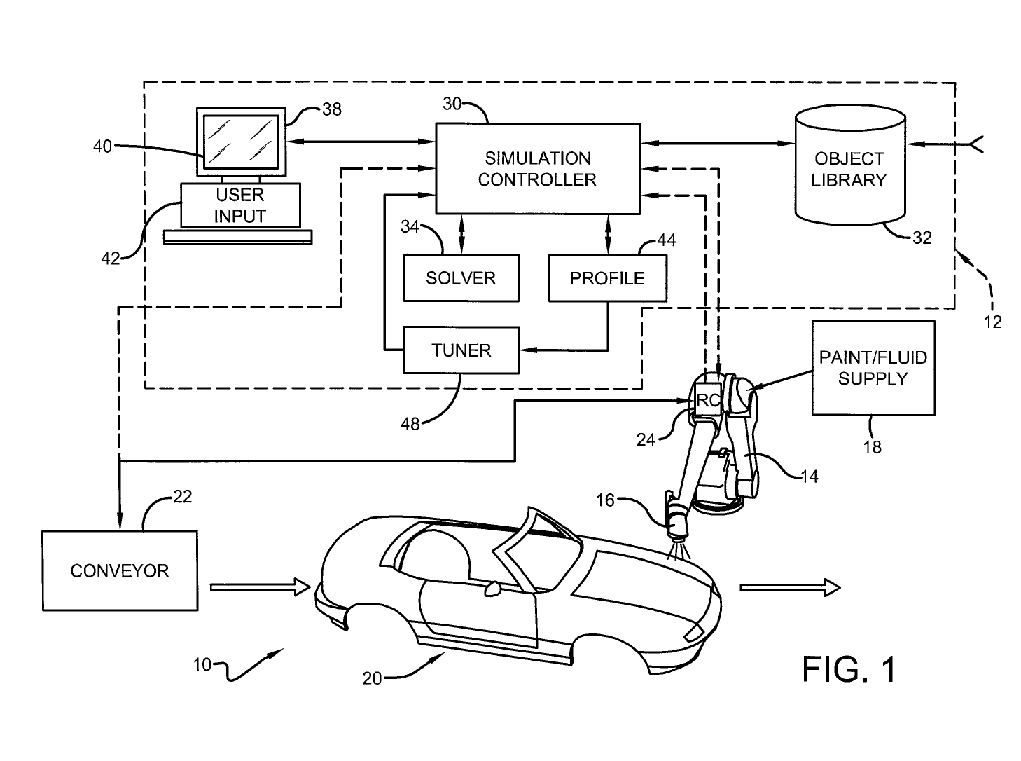

Referring now to FIG. 1, it can be seen that a paint application system is designated generally by the numeral 10. Although the system described herein is specifically used for dispensing of paint, those skilled in the art will appreciate that the system 10 may be utilized for dispensing any material onto an object. For example, adhesives, liquid crystal compositions, fungicides, or any other material where the thickness of the material being dispensed is a critical parameter can utilize the teachings of the present invention. The material dispensed may also be in the form of a powder, plasma or the like. In any event, the system 10 employs a paint simulation system designated generally by the numeral 12. As will be discussed in further detail, results of the simulation may be used in such a way as to minimize the actual set up and operation of the paint dispensing system. In other words, the system 10 incorporates the simulation system 12 and actual components such as at least one robot, at least one object, at least one conveyor, and all other related components. In various embodiments, the system 12 utilizes computer-generated models of at least one of, or any number of, the actual components in different combinations.

The system 10 includes a robot 14 which provides any number of degrees of motion as is commonly found in industrial applications. Although only a single robot is shown, it will be appreciated that the systems 10 and 12 may employ one or more robots. If multiple robots are employed, it will be appreciated that both systems 10 and 12 will coordinate the robot's collective operation and/or simulation. Associated with each robot 14 is a dispenser 16. The dispenser 16, which is configured to dispense the material in either fluid, powder or other appropriate form, is typically positioned at a working or distal end of the robot 14. In the present embodiment, the dispenser may be an atomizer or a spray gun, although other dispensing mechanisms may be employed. A paint/fluid/powder supply 18 is coupled to the robot 14 and the paint dispenser 16 so as to provide an appropriate amount of the material for the dispensing task.

An object 20 is positioned near the robot 14 and may be held stationary or moved along a conveyor. As will be discussed in regard to the simulation system 12, the object 20 is held stationary, although it is believed that the teachings of the present invention are applicable to simulations where the object is moved concurrently with the movement of the robot during its dispensing operation. And in other embodiments it is envisioned that the dispenser 16 is held stationary while a robot moves the object to obtain the desired material coverage. In some embodiments a conveyor system 22 may be employed to move the object 20 in relation to the robot. Generally, the object is positioned at a work station and the robot sequentially moves over the object while dispensing the paint. The sequential movement or path of the robot may also be referred to as the trajectory of the robot and/or the dispenser. It is desired for the paint thickness on the object to be sufficient to adequately cover the object and provide the desired durability during use of the object. It is also desired that the paint thickness should be sufficient to provide an adequate covering, but not too thick as excessive amounts of paint produces an uneven finish and results in wasted resources. As used herein, in some embodiments the term object may refer to a single component such as the hood of an automobile and in other embodiments, the term object may refer to multiple components such as an automobile body comprising a hood, doors, roof, fenders and so on.

A robot controller 24, which is designated as “RC,” is maintained by each robot 14 and includes the necessary hardware, software and memory to implement operation of the system 10. Moreover, the RC 24 is linked to the simulation system 12 so as to implement any simulation scenario developed by a paint application specialist as will be described. In some embodiments, a single RC 24 may be configured to control multiple robots 14.

The linking between the RC 24 and the simulation system 12 may be accomplished by transferring a completed simulation scenario by a network, including wired or wireless transmission, or by loading the simulation scenario via a computer storage medium such as a USB flash drive or the like.

The simulation system 12 includes a simulation controller 30 which utilizes the necessary hardware, software and memory for operating the simulation system 12 and the actual system 10. The controller 30 simulates operation of the robot 14 or robots, their dispensers 16 and, if appropriate, the conveyor 22. It will further be appreciated that the controller models each of these components so as to mimic their operational features to run simulations. Moreover, the controller 30 may be in communication with an object library database 32 that keeps the various shapes of objects likely to be painted on file. Additionally, the controller 30 may also maintain a database made up of characteristics of particular types of dispensers such as an atomizer or a spray gun, and also characteristics of possible materials being dispensed. It will be appreciated that the objects are most likely painted by an electrostatic process and the environmental conditions related to such a painting process are also maintained in an appropriate memory or database associated with the controller 30.

In order to operate the simulation system 12, the controller 30 calls on various sub-routines or sub-systems to implement the simulation. In particular, the controller 30 is connected to a solver 34. As skilled artisans will appreciate, the solver 34 implements selected equations to calculate paint droplet positions during a dispensing operation. As is well established in the art, Navier-Stokes equations can be used to represent the appearance and flow behavior of fluids or the like in computer graphic animations and special effects for movies. In the present embodiment the solver 34 utilizes modified Navier-Stokes equations to model the dispensing flow of paint from the material dispenser 16. These modified equations allow for life-like representations of the visual effects. However, none of the known modifications to Navier-Stokes equations provide for determining or simulating how the flow of a dispensed material, such as from the dispenser 16, accumulates on an object, and most notably on a multi-curved object such as a hood of an automobile. In order to determine a relative accumulated thickness of the paint on an object, the solver uses the following computer code:

• public void vel_step(float[, ,] thickness, float[, ,] u, float[, ,] v, float[, ,]
w,
• float[, ,] u0, float[, ,] v0, float[, ,] w0, float visc, float dt, int iter)
• {
• add_source(u, u0, dt); add_source(v, v0, dt); add_source(w, w0, dt);
• diffuse(thickness, 1, u0, u, visc, dt, iter);
• diffuse(thickness, 2, v0, v, visc, dt, iter);
• diffuse(thickness, 3, w0, w, visc, dt, iter);
• project(thickness, u0, v0, w0, u, v, iter);
• advect(thickness, 1, u, u0, u0, v0, w0, dt);
• advect(thickness, 2, v, v0, u0, v0, w0, dt);
• advect(thickness, 3, w, w0, u0, v0, w0, dt);
• project(thickness, u, v, w, u0, v0, iter);
• }

The simulation utilizes the modified Navier-Stokes equations in a step-by-step iterative process. In essence, the process simulates at least the trajectory path of the dispenser, the droplet flow pattern, and the shape of the object. Other parameters may also be simulated. The simulation is segmented into a series of time steps. Each period between each step may be 20 milliseconds. Of course, the time step may be adjusted to shorter or longer periods of time depending upon the needs of the technician. In any event, the object is partitioned into three-dimensional cells. At each time step, the robot trajectory is sequenced and the amount of paint droplets dispersed to each cell is quantified. Once all the time steps are completed the simulation determines how many droplets accumulate in each cell and this information can be quantified and/or schematically represented. It will also be appreciated that some embodiments of the invention may utilize simulations without the modified Navier-Stokes equations. This allows the technician to implement a “quick-run” which provides a relatively faster simulation. Such an embodiment provides a simulation that highlights significant areas of excess paint accumulation and/or areas of minimal paint coverage. The technician can then adjust the “quick-run” parameters. Once the “quick-run” simulation obtains an optimal result, the simulation embodiment that utilizes the modified Navier-Stokes equations can then be used. As will be appreciated, such a simulation requires more computing time, but provides a more accurate determination of paint/fluid/powder accumulation on an object.

Use of the above code allows for relatively rapid determination of paint droplet flow and accumulation based upon the constraints presented by the models representing the paint, the object, the dispensing system and the surrounding environment. The controller is also connected to a renderer 38 which is connected to a video display 40. The renderer, which is typically a graphics processing software component, generates a representation showing the calculated dispensing of the paint dispenser simulation. Indeed, the display may provide a multi-dimensional view of the object(s), the robot(s) and the trajectory path of the robot(s) in relation to the object(s). And the display provides for viewing of the various simulation embodiments.

A user input device 42 may be provided for allowing a user to adjust certain parameters of simulation. For example, the user may input different parameters, paint viscosity or other environmental characteristics to see how that changes output parameters such as the paint simulation and the determined relative thickness of the paint dispensed onto an object. The simulation may include a representation of the trajectory along with the various inputs and outputs that control dispensing of the material. This representation may include, but is not limited to, recording of the selected time intervals, the position of the robots, the position of each dispenser, and control signal values of the various inputs and outputs.

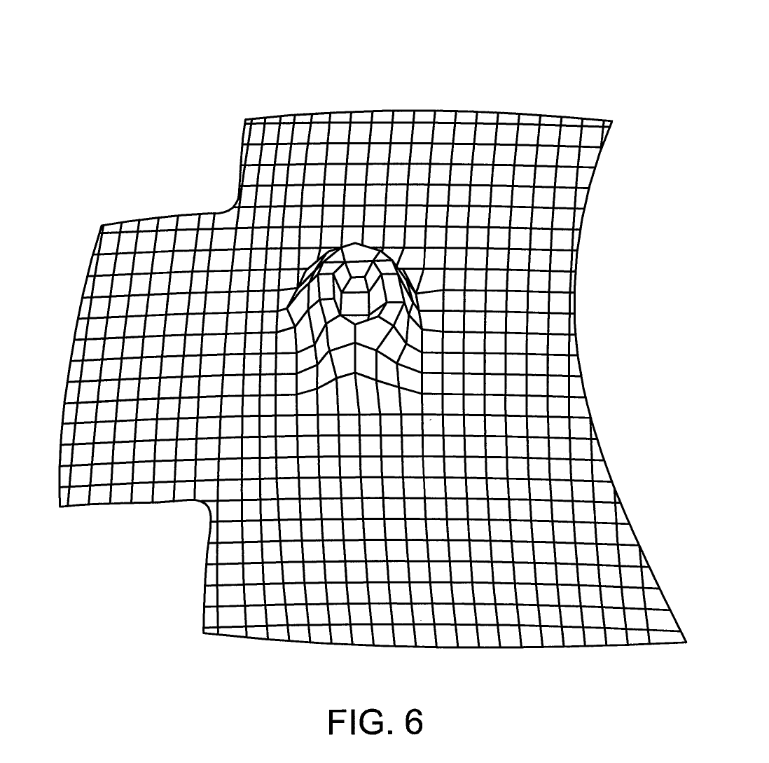

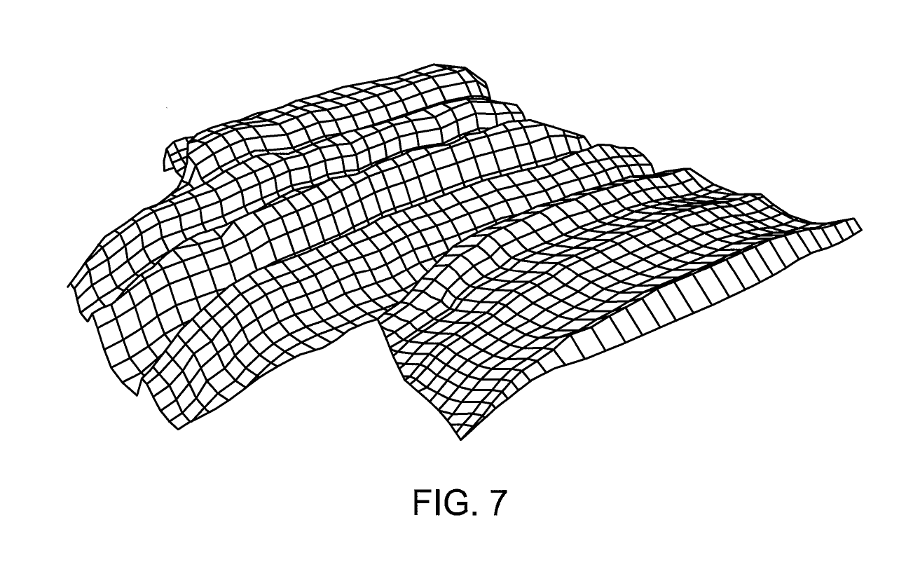

A profile 44 is associated with the controller 30. The controller 30 takes data generated by the solver 34 and the renderer 42 to generate a paint thickness profile on the object 20. The profile 44 may be in the form of pure data, a graph, or the profile may be visually represented as color/polygonal coded surfaces on the display 40. An exemplary two-dimensional profile or bit texture map is shown in FIG. 6 and an exemplary three-dimensional profile or depth map is shown in FIG. 7.

A tuner 48 receives input data from the profile 44 and generates adjustment input to the controller 30. In particular, the tuner 48 provides for adjustments to the trajectory and/or paint dispensing simulation variables—speed, height, path trajectory and so on—so as to adjust the relative thickness of the paint during the simulation. If desired, the simulation can be calibrated with real-life objects so as to obtain absolute thickness values of the material or paint. The adjustments may also include such things as the overlap ratio, wherein the overlap ratio defines how close adjacent paths are to one another. For example, a high overlap ratio indicates that adjacent paths are relatively close to one another and maximum paint coverage is obtained, although this may result in excess paint accumulation. Another adjustment relates to when the dispenser is turned off and on in relation to an edge of the object. As a result, the tuner 48 can provide for operating characteristics that obtain a desired relative paint thickness on an object. The iterations may be performed automatically so as to obtain an even coating by moving the path points, changing the on/off points, changing the spray rate and so on. In the alternative, the technician may adjust selected parameters in various “what if?” scenarios. After several iterations of the tuner and the paint simulation process, and once an optimized simulation is obtained, the results from the simulation can be transferred to the actual robot 14, the dispenser 16 and, if appropriate, the conveyor 22 so as to validate the simulation results. As discussed, the desired simulation scenario is uploaded or otherwise transferred to one or more robot controllers 24. At that time, specific adjustments can be made to the components of the paint dispensing system 10 so as to achieve a desired result.

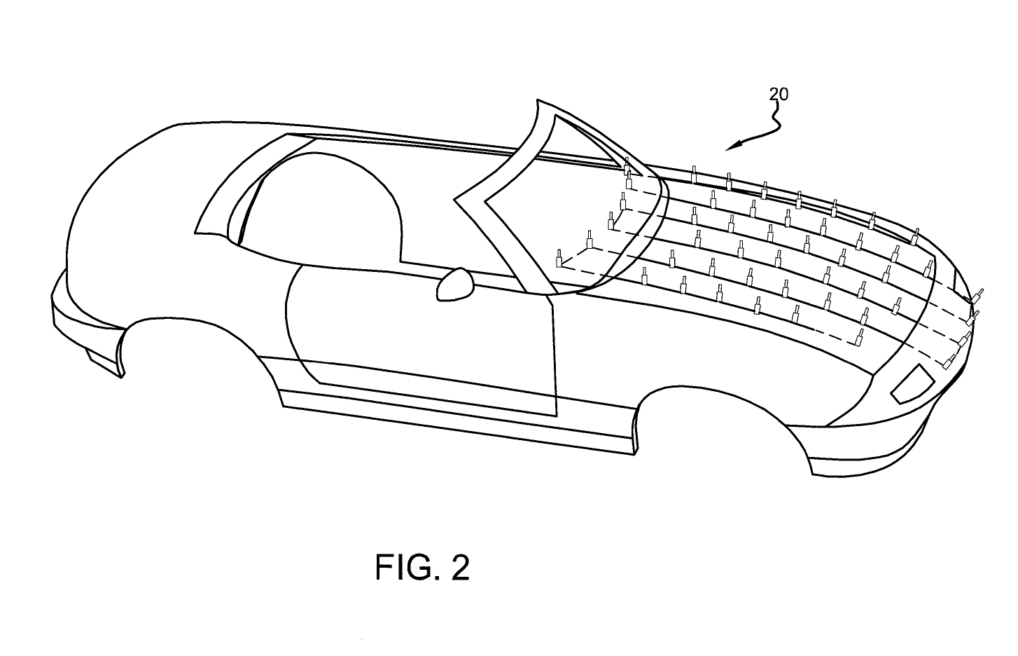

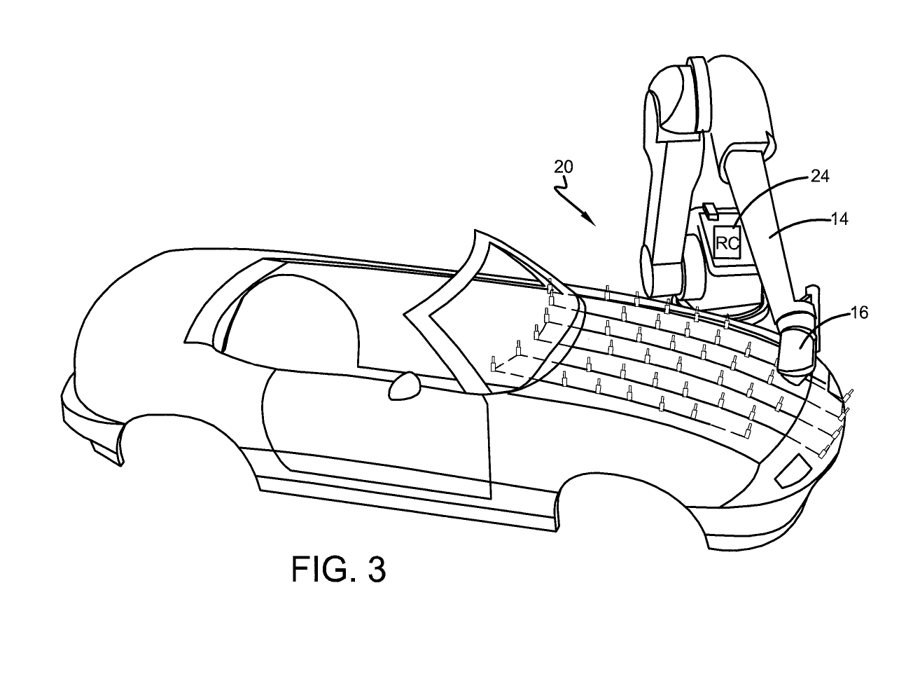

Referring now to FIGS. 2-7, the various steps in the simulation process are represented. In FIG. 2 it can be seen that an object 20 may be rendered or displayed and a plurality of markers 50 are positioned about the object so as to indicate to the robot where it needs to be positioned during a simulated painting process. If available, the object may be initially modeled based on a similar object stored in the library 32. Next, in FIG. 3, the robot path or trajectory is plotted by moving the robot from marker to marker along a proposed path trajectory. These position locations are incorporated into an appropriate memory or database and can be rearranged as determined by user input or the controller.

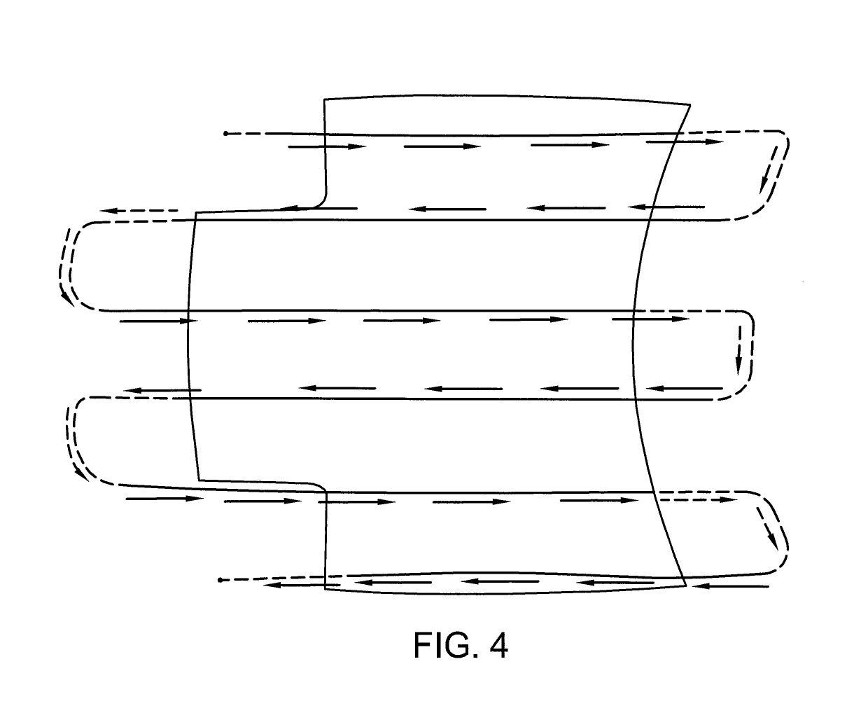

Referring now to FIG. 4, an exemplary trajectory path 52 is shown. The path is made up of areas where the paint dispensing operation takes place or, in other words, where the dispensing activity is on—solid line 54—and where the paint dispensing operation is turned off—dashed line 56. Accordingly, the path 52 indicates that the dispensing device is on primarily when passing over the object and, for a short period thereafter, and the dispensing device is off primarily while positioning to make the next dispensing path.

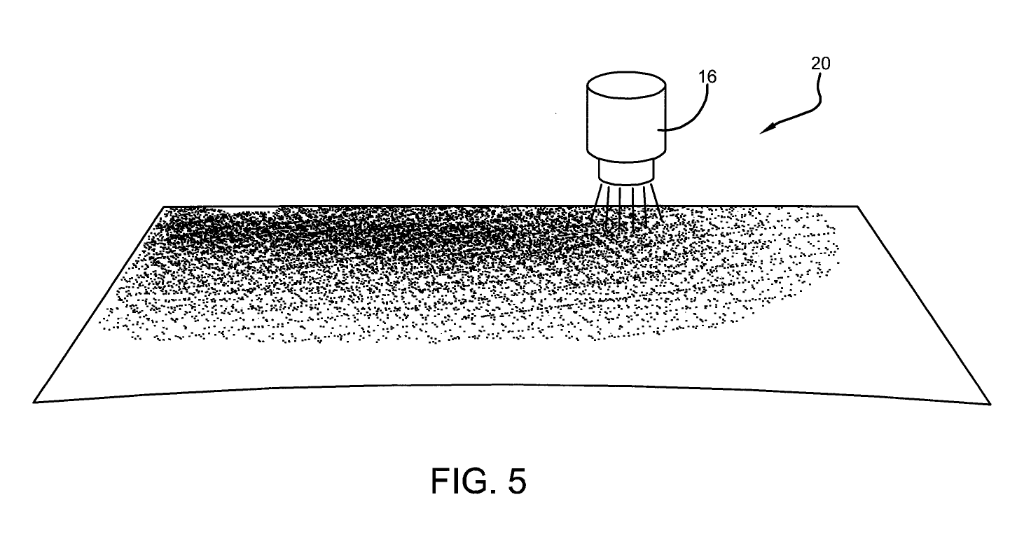

During a first simulation, the renderer provides for an image on a display, as represented in FIG. 5, so as to display to the user the painting operation and the trajectory path. This provides for a visual representation as to possible areas where the trajectory may be adjusted if it is later determined that a desired thickness is not obtained. As best seen in FIG. 6, a two-dimensional representation of a relative paint thickness is shown. As such, the user can adjust the trajectory or operation of the paint dispensing device so as to avoid such a high or relatively thick occurrence of the paint. To assist in highlighting the areas where relatively thick areas are present, the different raised areas may use different colors for representation on the display. In other words, a slightly raised area may have a blue color, a further raised area may have a green color, while an extreme raised area may have a red color. Referring to FIG. 7, a three-dimensional representation is shown which hi-lights areas where excessive paint is detected and also areas where minimal paint coverage is provided. The raised areas represent possible areas of paint dispensing overlap and, as such, the subject path trajectory could be conceivably spaced further apart so as to prevent the occurrence of such an overlap. As with the representation in FIG. 6, FIG. 7 may also be provided with color coding so that different raised areas are represented by different colors. Based upon the representations provided in FIGS. 6 and 7, the user can adjust certain parameters and initiate another simulation so as to determine the results and ultimately obtain a desired paint path trajectory by adjusting the variable operations so as to achieve a uniform and consistent paint thickness on an object. Once provided with this optimal simulation the parameters can be transferred or uploaded to the actual components for evaluation and validation of an actual paint dispensing operation.

Based on the foregoing, the advantages of the present invention are readily apparent. In particular, the disclosed invention provides a fast and fluid-like solution for robotics paint thickness simulation. This simulation makes it possible for end users to interactively visualize and optimize the painting process utilized in the robotics industry. The invention also provides a method to tune the robot trajectory based on paint thickness simulation data in order to achieve uniform paint coverage. In order to overcome the problems identified in the prior art, the Navier-Stokes equations with specific modifications are solved and the calculating time is reduced significantly so as to make the simulations repeatable and accurate. It will further be appreciated that the systems are able to create more realistic results due to enhanced computing power and graphical rendering technology. Still another advantage of the present invention is that simulations can be run for multiple adjacent objects. For example, instead of solely considering the accumulation amounts on a single object, such as a hood, accumulation amounts can also be determined for adjacent objects such as a door. The ability to run simulations for multiple objects that are adjacent one another or in close proximity to one another further improves the ability to save resources in setting up the actual painting of all the objects and optimization of the painting process. This advantage provides a “global” solution for multi-piece objects such as an automobile. Based upon these improvements it is believed that incorporation of movement of the object during the painting operation can also be obtained.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

1. A system for tuning robot trajectory to obtain optimal material thickness on an object, comprising:
at least one robot adapted to dispense material;
a controller connected to said robot so as to control movement of said robot and dispensing of the material in relation to the object; and
a tuner connected to said controller to iteratively simulate dispensing of the material on the object based on movement of said robot, and to adjust dispensing of the material and movement of said robot to obtain a desired material thickness on the object based on the iterative simulations.

2. The system according to claim 1, further comprising:
a solver connected to said controller, said solver calculating positions of material droplets exiting from said material dispensing robot.

3. The system according to claim 2, wherein said solver utilizes modified Navier-Stokes equations to calculate the positions of the material droplets on the object.

4. The system according to claim 2, further comprising:
a renderer connected to said controller, said renderer displaying positions of the material droplets emanating from the robot and their position on the object.

5. The system to claim 2, further comprising:
a profile generated by said controller, said profile providing a determination of relative material thickness on the object.

6. The system according to claim 5, wherein said profile is utilized in actual operation of a material application system.

7. The system according to claim 1, wherein said at least one robot is a computer-generated model.

8. The system according to claim 1, wherein said at least one robot is configured for actual operation to dispense material to the desired material thickness.

9. A method to optimize dispensing material on an object, comprising:
simulating a path trajectory of a material dispensing robot in relation to an object;
simulating dispensing of material along said path trajectory;
determining a relative thickness of material on the object; and
tuning said simulating steps to adjust and obtain a desired relative thickness of the material on the object.

10. The method according to claim 9, further comprising:
implementing said simulating steps of said material dispensing robot on an object into actual path trajectory and dispensing steps on an actual object.

11. The method according to claim 9, further comprising:
calculating positions of material droplets during the material dispensing simulating step.

12. The method according to claim 11, further comprising:
utilizing modified Navier-Stokes equations to calculate position of material droplets and position of the droplets on the object to determine a relative thickness of the material.

13. The method according to claim 11, further comprising:
rendering a representation of the relative thickness of the material on the object.

14. A method of predicting coverage and relative thickness of material dispensed by at least one robot on at least one object, comprising:
displaying a multi-dimensional view of the at least one object, the at least one robot, and a trajectory of the at least one robot in relation to the at least one object;
simulating the trajectory along with inputs and outputs that control the material dispensed;
recording the output of the simulation;
simulating the material flow from said at least one robot on to the at least one object; and
generating and displaying a material thickness representation on the object.

15. The method according to claim 14, further comprising:
displaying three-dimensional views of the at least one object, the at least one robot, and the trajectory.

16. The method according to claim 15, further comprising:
recording at selected time intervals the positions of the at least one robot, the position of a dispenser associated with each said robot, and control signal values of said inputs and outputs.

17. The method according to claim 16, further comprising:
displaying a two-dimensional bit texture map of material thickness on the at least one object.

18. The method according to claim 16, further comprising:
displaying a three-dimensional depth map of material thickness on the at least one object.

19. A method for simulating material flow on to an object comprising:
representing a multi-dimensional object on a display;
simulating motion of a movable material dispensing device in relation to said multi-dimensional object on said display;
simulating on said display a flow of material from said movable material dispensing device on to said multi-dimensional object; and
representing accumulation of material on said multi-dimensional object for viewing on said display.

20. The method according to claim 19, further comprising:
determining accumulation of material flow on to said multi-dimensional object with modified Navier-Stokes equations.

21. The method according to claim 20, further comprising:
simulating motion of said multi-dimensional object during motion of said movable material dispensing device.
